(19) United States
(12) Patent Application Publication
(10) Pub. No.: US 2023/0027189 A1
(43) Pub. Date: Jan. 26, 2023

(54) SELF-ADAPTIVE ELECTRIC TOOTHBRUSH

(71) Applicant: CONSTAR MOTION CO.,LTD., Shenzhen (CN)

(72) Inventors: Zhenjian Zhang, Shenzhen (CN); Chuansong Qiu, Shenzhen (CN); Dong Liu, Shenzhen (CN); Chuan Yang, Shenzhen (CN); Changjun Wang, Shenzhen (CN); Hongping Song, Chongqing (CN)

(73) Assignee: CONSTAR MOTION CO.,LTD., Shenzhen (CN)

(21) Appl. No.: 17/869,817

(22) Filed: Jul. 21, 2022

(30) Foreign Application Priority Data
Jul. 21, 2021 (CN) 202110825800.7

(51) Int. Cl. A61C 17/34

(52) U.S. Cl. CPC A61C 17/3481; A61C 17/3418

(57) ABSTRACT

A self-adaptive electric toothbrush includes a handle and a brush head. A vibrating motor is arranged in the handle. Bristles are arranged on the brush head. An output shaft of the vibrating motor extends out of the handle and is connected to the brush head through a delay structure. By the delay structure, the brush head remains stationary or the amplitude of the oscillation of the brush head is less than the amplitude of the oscillation of the output shaft after the vibrating motor is activated and before pressure is applied to the bristles. After pressure is applied to the bristles, the amplitude of the oscillation of the brush head is greater than the amplitude of the oscillation before pressure is applied. In the self-adaptive electric toothbrush, before the pressure is applied, the brush head is stationary or the amplitude of oscillation is small.

### CROSS REFERENCE TO THE RELATED APPLICATIONS

This application is based upon and claims priority to Chinese Patent Application No. 202110825800.7, filed on Jul. 21, 2021, the entire contents of which are incorporated herein by reference.

### TECHNICAL FIELD

The present invention relates to the technical field of electric toothbrushes, and particularly to a self-adaptive electric toothbrush.

### BACKGROUND

Due to the rapid development of technology, toothbrushes are also being updated. The development from previous manual toothbrushes to the current electric toothbrushes has become an inevitable trend. Electric toothbrushes were originally designed and developed for those with mobility problems or lazy people, and slowly popularized that anyone can use. Electric toothbrushes automatically clean teeth once the switch buttons being pushed, and there are multiple cleaning modes which is very convenient.

Typically, in an electric toothbrush, the brush head has an interference fit with the output shaft. The brush head is in synchronous movements keeping up with the reciprocating vibration of the motor to clean teeth, but the brush head of the electric toothbrush automatically turns into a normal working mode once started. The problems of toothpaste splatter before users actually start brushing their teeth, as well as foam splatter after the brush head of the electric toothbrush is taken out of the mouth after the foam is formed during the brushing process are prone to occur, resulting in poor user's experiences.

### SUMMARY

In view of this, the present invention provides a self-adaptive electric toothbrush that can avoid the problem of toothpaste splashing.

The technical solution is as follows. A self-adaptive electric toothbrush includes a handle and a brush head. A vibrating motor is arranged in the handle. Bristles are arranged on the brush head. The key is that an output shaft of the vibrating motor extends out of the handle and is connected to the brush head through a delay structure. Through the delay structure, the brush head remains stationary or the amplitude of the oscillation of the brush head is less than the amplitude of the oscillation of the output shaft after the vibrating motor is activated and before pressure is applied to the bristles. After pressure is applied to the bristles, the amplitude of the oscillation of the brush head is greater than the amplitude of the oscillation before pressure is applied. With the above technical solution, before the pressure is applied, that is, before the bristles are pressed on the teeth, the brush head is stationary or the amplitude of oscillation is small, which can prevent the problem of splatter toothpaste due to the too large amplitude of oscillation, and can further significantly reduce the problem of splashing foam after the brush head of the electric toothbrush being taken out of the mouth after the foam is formed during the brushing process. Meanwhile, before pressure is applied, the reciprocating oscillation of the vibrating motor must overcome smaller inertia. Relatively, the reaction force on the handle is further smaller, and thus, the handle vibration to overcome inertia is also relatively small, which affords the user a better handle sensation and greatly improves user experience.

Further, the delay structure includes a connection hole arranged inside the brush head and at least one delay plane which is arranged on the output shaft along the axial direction of the output shaft. A plane matching the delay plane is arranged on the hole wall of the connection hole. The output shaft is inserted into the connection hole, and the delay plane is directly facing the corresponding plane in the connection hole. A delay gap is formed between the delay plane and the corresponding plane. By configuring the structure, no additional parts are required, and it is very convenient to process and install.

After the output shaft rotates 1-30° clockwise or counterclockwise, the output shaft can drive the brush head to rotate. By configuring the structure, the movement trajectory of the bristles is fan-shaped during brushing teeth, and this angle simulating the angle of bristles brings a better experience.

The pressure applied to the bristles has a component force F in the direction perpendicular to the bristles, and a 50-500 gram-force (gf) of F is enough to increase the amplitude of the oscillation of the brush head.

N denotes the number of resilient cushioning members are arranged in the delay gap, where N is a natural number. By configuring the structure, the resilient cushioning members can play a role in reducing noise.

The resilient cushioning member is either an independent part, fixedly arranged in the brush head, or fixedly arranged on the output shaft. By configuring the structure, the resilient cushioning member can be arranged in different forms depending on factors such as the cost of processing and assembly and the like.

The resilient cushioning member is made from a soft material, which can be deformed after the force is applied.

The resilient cushioning member can have a structural configuration that provides the resilient cushioning member with the capability of deforming by processing.

The resilient cushioning member is sheet-shaped, spiral-shaped, saddle-shaped, or wave-shaped.

The output shaft is provided with a shaft sleeve. The output shaft is fitted with the shaft sleeve by the delay structure, and the shaft sleeve is fixedly arranged in the brush head. By configuring the structure, a shaft sleeve, a steel sleeve, a plastic sleeve, and other structures can be arranged on the output shaft according to the process or other needs.

Compared to the prior art, the present invention has following advantages. Before the pressure is applied, that is, before the bristles are pressed against the teeth, the brush head is stationary or the amplitude of oscillation is small, which can prevent the problem of splattering toothpaste due to the too large amplitude of oscillation, and can further significantly reduce the problem of splashing foam after the brush head of the electric toothbrush is taken out of the mouth after the foam is formed during the brushing process. At the same time, before the pressure is applied, the reciprocating oscillation of the vibrating motor must overcome smaller inertia. Relatively, the reaction force on the handle is further smaller, thus the handle vibration is smaller, greatly improving the user's experience.

### BRIEF DESCRIPTION OF THE DRAWINGS

FIG. 1 is an exploded view of the present invention.

FIG. 2 is a schematic diagram showing a planar structure of the present invention.

FIG. 3 is an A-A′ cross section view of FIG. 2.

FIG. 4 is a B-B′ cross section view of FIG. 2.

FIG. 5 is a schematic diagram showing the structure of a delay plane arranged with two sheet-shaped resilient cushioning members.

FIG. 6 is a schematic diagram showing a structure arranged with a wave-shaped resilient cushioning member.

FIG. 7 is a schematic diagram showing a structure arranged with a saddle-shaped resilient cushioning member.

FIG. 8 is a schematic diagram showing a structure arranged with a spiral-shaped resilient cushioning member.

FIG. 9 is a schematic diagram showing the structure of two delay planes each arranged with a resilient cushioning member.

FIG. 10 is a schematic diagram showing the structure of two delay planes each arranged with a resilient cushioning member and the other positions of an output shaft arranged with resilient cushioning members.

### DETAILED DESCRIPTION OF THE EMBODIMENTS

The present invention is further described in the following embodiments in conjunction with the drawings.

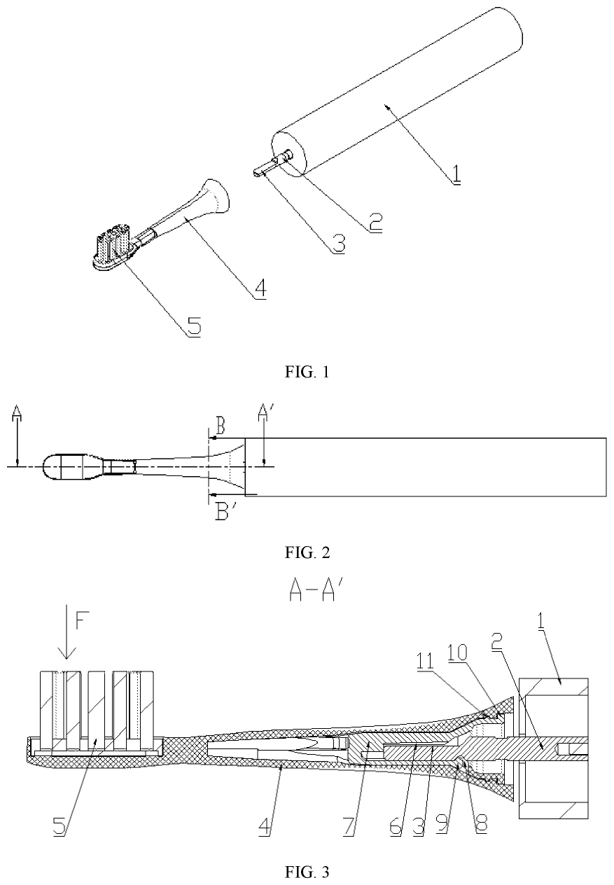

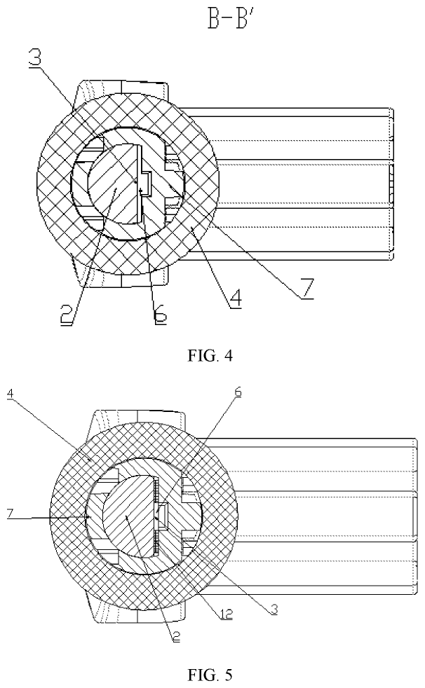

As shown in FIGS. 1-4, a self-adaptive electric toothbrush includes the handle 1 and the brush head 4. A vibrating motor is arranged in the handle 1. The bristles 5 are arranged on the brush head 4. The output shaft 2 of the vibrating motor extends out of the handle 1 and is connected to the brush head 4 through a delay structure. By the delay structure, the brush head 4 remains stationary or the amplitude of the oscillation of the brush head 4 is less than the amplitude of the oscillation of the output shaft 2 after the vibrating motor is activated and before pressure is applied to the bristles 5. After pressure is applied to the bristles 5, the amplitude of the oscillation of the brush head 4 is greater than the amplitude of the oscillation before pressure is applied.

The delay structure includes a connection hole arranged inside the brush head 4 and at least one delay plane 3 which is arranged on the output shaft 2 along the axial direction of the output shaft 2. A plane matching the delay plane 3 is arranged on the hole wall of the connection hole. The output shaft 2 is inserted into the connection hole, the end part of the output shaft 2 closely abuts against the bottom of the connection hole, and the delay plane 3 is directly facing the corresponding plane in the connection hole. The delay gap 6 is formed between the delay plane 3 and the corresponding plane. In this embodiment, the output shaft 2 is sleeved with the shaft sleeve 7, and the output shaft 2 fits with the shaft sleeve 7 by the delay structure, that is the shaft sleeve 7 is provided with the connection hole inside. At the same time, in order to ensure an axial seamless fit between the output shaft 2 and the shaft sleeve 7, the first snap hole 8 is provided on the plane, opposite to the delay plane 3, of the output shaft 2, and the first snap 9 is correspondingly provided on the shaft sleeve 7. The first snap 9 is snapped tightly into the first snap hole 8. The shaft sleeve 7 is fixedly arranged in the brush head 4. In order to conveniently disassemble the shaft sleeve 7, the outer wall of the shaft sleeve 7 is provided with the two second snaps 11 at least, and the second snap holes are correspondingly arranged on the hole wall of the connection hole. The second snaps 11 are correspondingly snapped tightly into the second snap holes. The end part of the shaft sleeve 7 is folded outwards to form the contact surface 10, and the connection hole is provided with a contact step matching with it inside. The contact surface 10 closely abuts against the contact step. Optionally, the output shaft 2 could be arranged without the shaft sleeve, at the same time the inner wall of the connection hole is provided with the first snap 9.

After the output shaft 2 rotates 1-30° clockwise or counterclockwise, the delay gap 6 is overcome and the output shaft 2 drives the brush head 4 to rotate. The pressure applied to the bristles 5 has a component force F in the direction perpendicular to the bristles 5, and a 50-500 gram-force (gf) of F is enough to increase the amplitude of the oscillation of the brush head 4. Usually, a user applies a force directly perpendicular to the bristles 5 during usage, so the force is equal to 50-500 gf.

As shown in FIG. 5, the N resilient cushioning members 12 are arranged in the delay gap 6, where N is a natural number. The resilient cushioning member 12 is either an independent part, fixedly arranged in the brush head 4, or fixedly arranged on the output shaft 2. If the resilient cushioning member 12 is an independent part, it directly clamps closely into the delay gap 6; if the resilient cushioning member 12 is fixedly arranged on the output shaft 2, it is directly fixed on the delay plane 3; and if the resilient cushioning member 12 is fixedly arranged in the brush head 4, it is fixed on the plane inside the connection hole that corresponds to the delay plane 3.

The resilient cushioning member 12 is made from a soft material, which can be deformed after the force is applied, such as rubber, silicone, foam rubber, and the like.

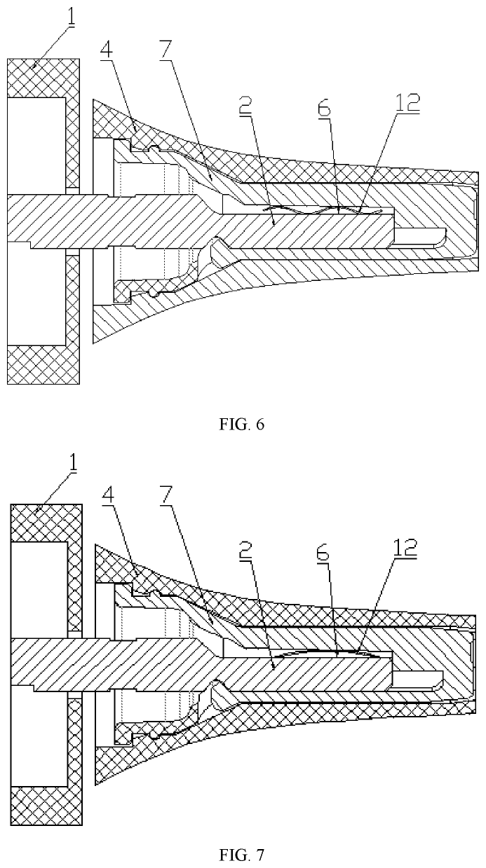

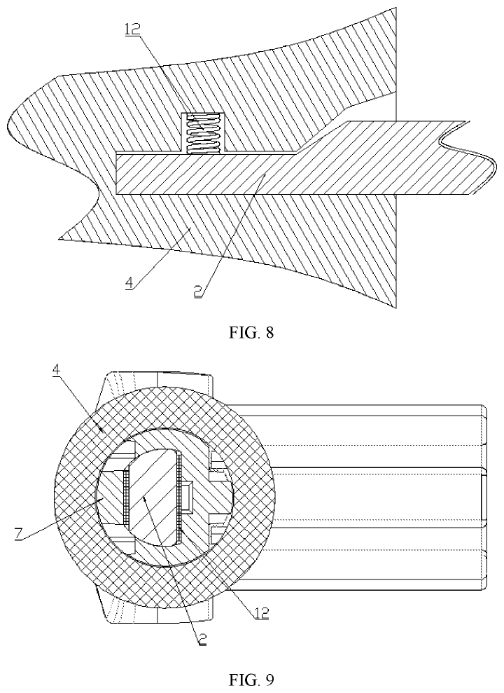

The resilient cushioning member 12 can have a structural configuration that provides the resilient cushioning member with the capability of deforming by processing, such as a metal spring, a metal resilient plate, or a resilient plastic part or structure. Further, the resilient cushioning member 12 can be sheet-shaped. As shown in FIG. 5, the output shaft 2 is provided with the delay plane 3, and the inside of the delay gap 6 is provided with the two sheet-shaped resilient cushioning member 12. Optionally, the resilient cushioning member 12 can be directly arranged as a whole piece, and other arranging circumstances are not shown here. The resilient cushioning member 12 can further be wave-shaped, as shown in FIG. 6. The resilient cushioning member 12 can further be saddle-shaped, as shown in FIG. 7. The resilient cushioning member 12 can further be spiral-shaped, as shown in FIG. 8, at this time, the connection hole is provided with a matching hole inside, and the spiral-shaped resilient cushioning member includes one end abutting against the delay plane 3, and the other end abutting against the matching hole.

As shown in FIG. 9, the output shaft 2 is provided with the two delay planes 3, and they are opposite to each other. The two delay planes 3 are each fitted with a piece of the sheet-shaped resilient cushioning member 12, which is made of rubber.

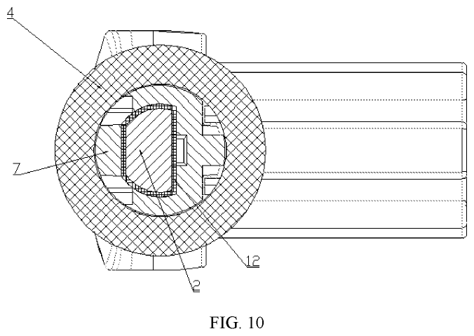

As shown in FIG. 10, the output shaft 2 is provided with the two delay planes 3, and they are opposite to each other. The two delay planes 3 are each fitted with a piece of the sheet-shaped resilient cushioning member 12. Further, the resilient cushioning member 12 can be arranged on other curved surfaces of the output shaft 2, or the resilient cushioning member 12 can be only arranged on one of the delay planes 3 if the output shaft 2 is provided with at least two delay planes 3.

In operation, the vibrating motor drives the output shaft 2 to vibrate in the circumferential direction. At this time, due to the existence of the delay gap 6, the output shaft 2 and the brush head 4 in the circumferential direction are having a loose fit, so when the brush head 4 remains stationary or has a slight vibration, the brush head 4 is not synchronized with the output shaft 2. When a pressure is applied to the bristles, the additional pressure applied eliminates or partially eliminates the delay gap 6 between the output shaft 2 and the brush head 4. When the remaining delay gap 6 reduces, the reciprocating motion made by the output shaft 2 driving the brush head 4 will be more synchronized, which eventually showcases that when additional pressure is applied to the brush head 4, a reciprocating oscillation made by the brush head 4 with the output shaft 2 is greater than that without additional pressure applied.

Finally, it should be noted that the above description is only a preferred embodiment of the present invention, and the skilled in the art may, under the inspiration of the present invention, make a variety of similar representations without violating the purpose and claims of the present invention, and such transformations should all fall within the scope of protection of the present invention.

What is claimed is:

1. A self-adaptive electric toothbrush, comprising a handle and a brush head, wherein a vibrating motor is arranged in the handle, and bristles are arranged on the brush head, wherein an output shaft of the vibrating motor extends out of the handle and the output shaft is connected to the brush head through a delay structure; by the delay structure, the brush head remains stationary or an amplitude of an oscillation of the brush head is less than an amplitude of an oscillation of the output shaft after the vibrating motor is activated and before a pressure is applied to the bristles; after the pressure is applied to the bristles, the amplitude of the oscillation of the brush head is greater than the amplitude of the oscillation of the brush head before the pressure is applied to the bristles.

2. The self-adaptive electric toothbrush according to claim 1, wherein the delay structure comprises a connection hole and at least one delay plane, wherein the connection hole is arranged inside the brush head, the at least one delay plane is arranged on the output shaft along an axial direction of the output shaft; a plane is arranged on a hole wall of the connection hole, wherein the plane matches the at least one delay plane; the output shaft is inserted into the connection hole; the at least one delay plane is directly facing a plane in the connection hole; and a delay gap is formed between the at least one delay plane and the plane in the connection hole.

3. The self-adaptive electric toothbrush according to claim 2, wherein after the output shaft rotates 1-30° clockwise or counterclockwise, the output shaft is configured to drive the brush head to rotate.

4. The self-adaptive electric toothbrush according to claim 1, wherein the pressure applied to the bristles has a component force F in a direction, wherein the direction is perpendicular to the bristles, and a 50-500 gram-force (gf) of F is enough to increase the amplitude of the oscillation of the brush head.

5. The self-adaptive electric toothbrush according to claim 4, wherein N resilient cushioning members are arranged in the delay gap, wherein N is a natural number.

6. The self-adaptive electric toothbrush according to claim 5, wherein the each of N resilient cushioning members is an independent part, or each of the N resilient cushioning members is fixedly arranged in the brush head, or each of the N resilient cushioning members is fixedly arranged on the output shaft.

7. The self-adaptive electric toothbrush according to claim 5, wherein each of the N resilient cushioning members is made from a soft material, wherein each of the N resilient cushioning members is configured to be deformed after a force is applied.

8. The self-adaptive electric toothbrush according to claim 5, wherein each of the N resilient cushioning members is in a structural configuration, wherein the structural configuration provides each of the N resilient cushioning members with a capability of deforming by processing.

9. The self-adaptive electric toothbrush according to claim 8, wherein each of the N resilient cushioning members is sheet-shaped, spiral-shaped, saddle-shaped, or wave-shaped.

10. The self-adaptive electric toothbrush according to claim 1, wherein the output shaft is sleeved with a shaft sleeve; the output shaft is fitted with the shaft sleeve by the delay structure; and the shaft sleeve is fixedly arranged in the brush head.

11. The self-adaptive electric toothbrush according to claim 2, wherein the pressure applied to the bristles has a component force F in a direction, wherein the direction is perpendicular to the bristles, and a 50-500 gf of F is enough to increase the amplitude of the oscillation of the brush head.

12. The self-adaptive electric toothbrush according to claim 3, wherein the pressure applied to the bristles has a component force F in a direction, wherein the direction is perpendicular to the bristles, and a 50-500 gf of F is enough to increase the amplitude of the oscillation of the brush head.
